(19) United States
(12) Patent Application Publication
(10) Pub. No.: US 2012/0085249 A1
(43) Pub. Date: Apr. 12, 2012

(54) ASSEMBLED PEELER

(76) Inventor: Huo Feng Hsia KUAN, Hsin-Tien (TW)

(21) Appl. No.: 12/899,876

(22) Filed: Oct. 7, 2010

(51) Int. Cl. A47J 17/02; A47J 17/04; B26B 11/00

(52) U.S. Cl. 99/584; 30/123.5

(57) ABSTRACT

The present invention relates to an assembled peeler, comprising: a rod-shaped handle, the front thereof is axially and protrudingly installed with a buckling tenon or radially installed with a buckling slot; and at least one knife rack, the front thereof is formed with an opening for receiving a knife tool, and the rear of each knife rack is radially installed with a buckling slot or axially and protrudingly installed with a buckling tenon; the handle and the knife rack being combined as one piece through radially inserting the buckling tenon into the buckling slot, such that the knife tool of the knife rack being able to be axially forced for food process operations such as peeling, chopping, slicing, grinding or splitting, so the safety for users is ensured.

### BACKGROUND OF THE INVENTION

1. Field of the Invention

The present invention relates to a peeler, especially to a multi-function assembled peeler capable of selecting a suitable knife rack to be assembled for satisfying requirements of cooking processes such as peeling, chopping, slicing, grinding or splitting.

2. Description of Related Art

It is a long history about human eating vegetables and fruits. Nowadays people have more purchasing power and have higher expectations and requirements for finer and more delicate foods. Housewives or those who like to eat uncooked vegetables and fruits know that for block-shaped or strip-shaped vegetables and fruits, such as potatoes, apples, kiwis, cucumbers, carrots, cabbages, and etc., operations of peeling, slicing or chopping can be an irrigating work, and often cut themselves accidentally, unless they are professional chefs with mature experience. Thus merchandisers or skilled people in this art have developed peelers and chop boards for improving the disadvantages.

A conventional peeler is composed by a Y-shaped rack member and an arc-shaped peeling knife installed at an open end of the rack member, so the peeling knife is able to be in contact with the food to be processed at all time, such as a potato. Because the Y-shaped rack member is integrally made, it is not possible to replace with another knife tool having a different purpose or function, therefore only a peeling function can be provided; if a chopping operation is desired, a vegetable chopping plate, which is a plate-shaped peeling net equipped with several oblique peeling holes; when the food to be processed, such as a carrot is passed through the peeling holes, the food is chopped to filament-like shapes; but due to the size of the plate-shaped peeling net, it is not likely to reduce the size thereof into a hand-holding size.

In view of the disadvantages of the mentioned peeler and chopping board which only have one function, peelers equipped with different types of knife tools are developed by manufacturers, the peeler is mostly composed by a Y-shaped rack member being equipped with a knife tool at its open end for providing functions of peeling, chopping, slicing, grinding or splitting; thus during the food processing period, peelers with various types of knife tools can be selected according to actual needs, but storing the plural peelers is also an issue to be solved.

As a result, manufacturers have developed a peeler capable of changing and replacing knife rack, the peeler has a handle and a plurality of knife racks having different knife tools. When being assembled, the knife rack is axially and directly inserted into the handle, in other words the plural knife racks can be individually combined with the handle. The advantage of the assembled peeler is that the storing space is greatly reduced, but the disadvantage is that the knife tool is installed at the open end of the Y-shaped rack member, if the knife rack is desired to be installed or released from the handle, a user has to apply an axial force, and the user's hands may touch the knife tool and being injured, so the disadvantage shall be improved.

### SUMMARY OF THE INVENTION

One primary object of the present invention is to provide an assembled peeler in which a handle and a knife rack thereof are assembled or disassembled in a radial direction, such that hands of a user are prevented from touching a knife tool of the knife rack so as to ensure the user's safety.

Another object of the present invention is to provide an assembled peeler in which an opening of knife rack is able to be pivoted with various knife tools for being equipped with different food processing functions such as peeling, chopping, slicing, grinding or splitting.

For achieving the mentioned objects, the present invention provides an assembled peeler, comprises: a rod-shaped handle, the front thereof is axially and protrudingly installed with a buckling tenon or radially installed with a buckling slot; and

at least one knife rack, the front thereof has an opening for receiving a knife tool, and the rear of each knife rack is radially installed with a buckling slot or axially and protrudingly installed with a buckling tenon;

the handle and the knife rack are assembled as one piece through the buckling tenon being radially inserted into the buckling slot, such that the knife tool provided on the knife rack can be subject to an axial force and be prevented from releasing.

### BRIEF DESCRIPTION OF THE DRAWINGS

FIG. 1a and FIG. 1b are perspective exploded views of the assembled peeler of the present invention being viewed from two different angles;

FIG. 2 is a perspective view of the assembly of the assembled peeler of the present invention;

FIG. 3 is a cross sectional view of FIG. 2 intercepted along an A-A line;

FIG. 4 is a perspective view of the knife rack of the second embodiment of the present invention;

FIG. 5 is a perspective view of the knife rack of the third embodiment of the present invention;

FIG. 6 is a perspective view of the knife rack of the fourth embodiment of the present invention;

FIG. 7 is a perspective view of the knife rack of the fifth embodiment of the present invention;

FIG. 8 is a perspective view of the knife rack of the sixth embodiment of the present invention;

FIG. 9 is a perspective view of the knife rack of the seventh embodiment of the present invention;

FIG. 10 is a perspective view of the knife rack of the eighth embodiment of the present invention;

FIG. 11 is a perspective view of the knife rack of the ninth embodiment of the present invention.

### DETAILED DESCRIPTION OF THE PREFERRED EMBODIMENT

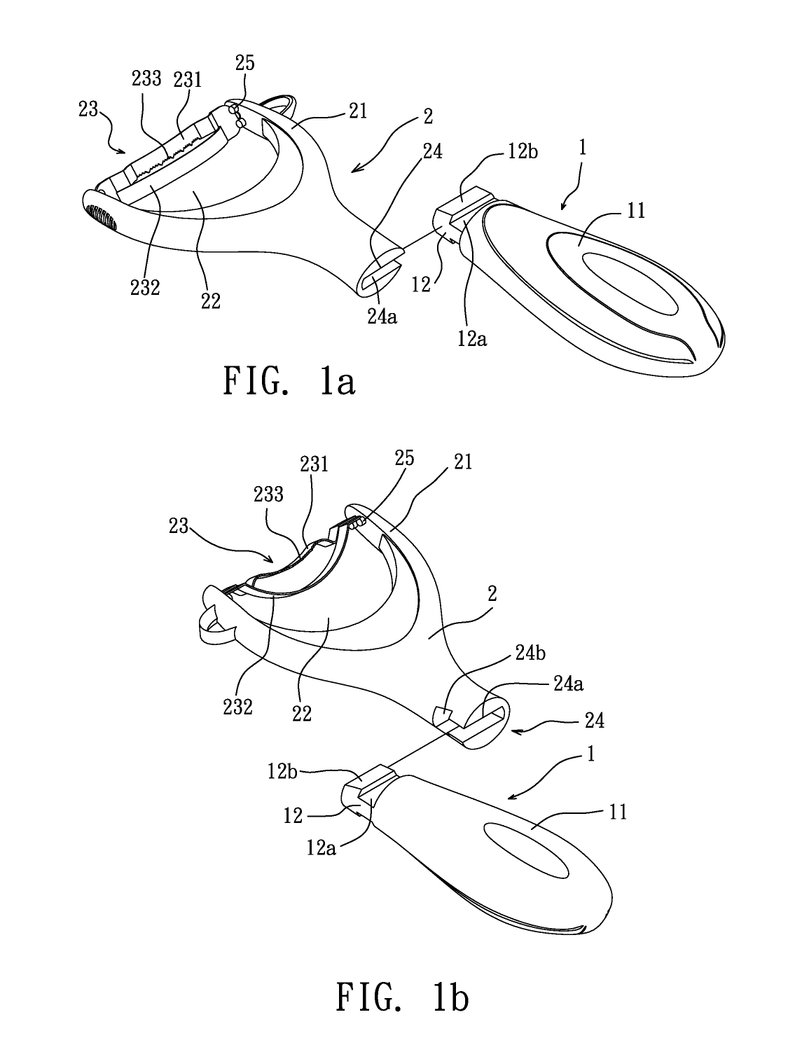

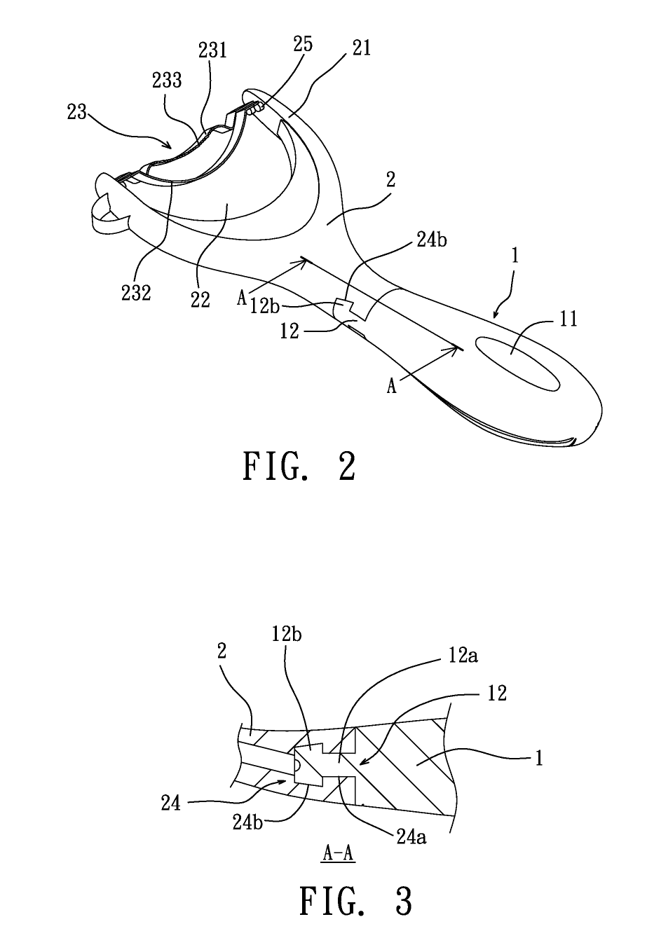

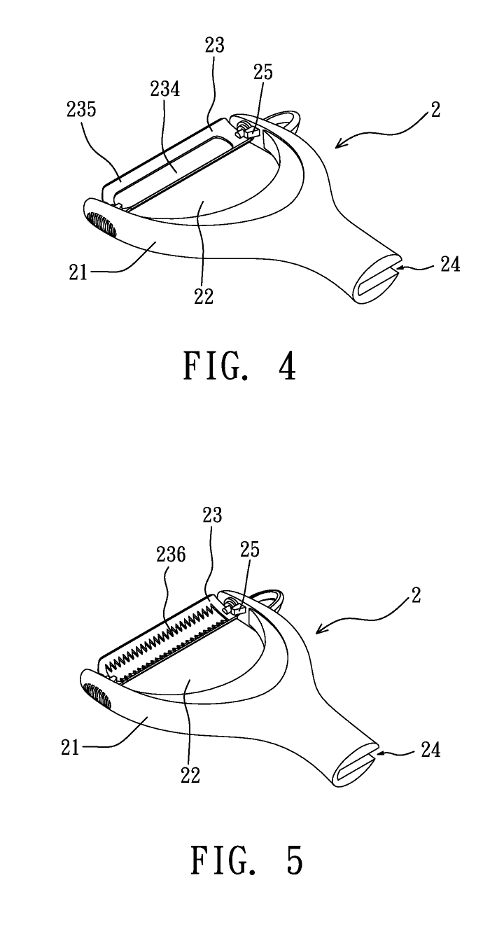

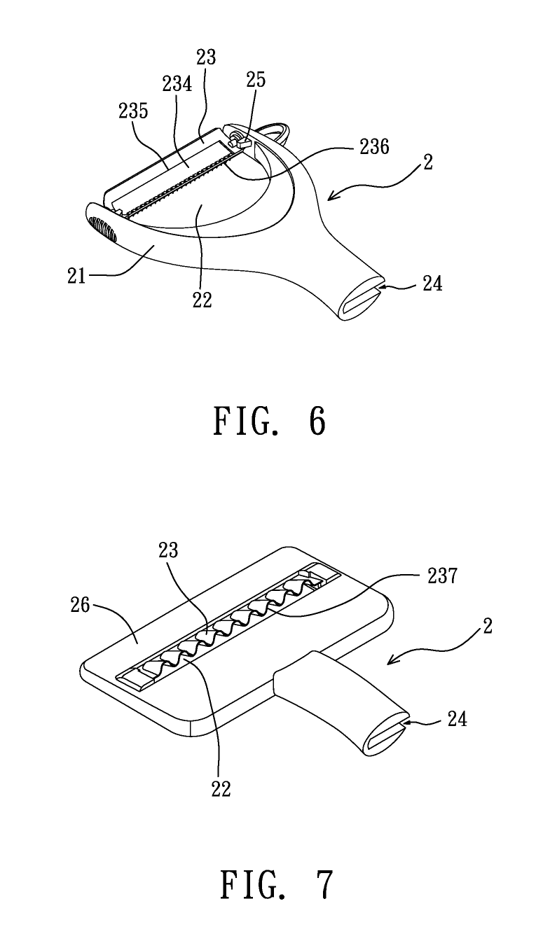

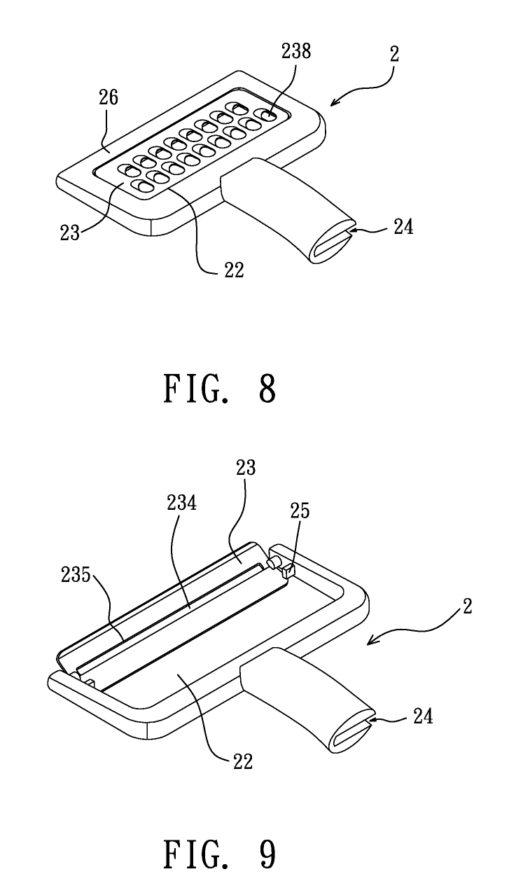

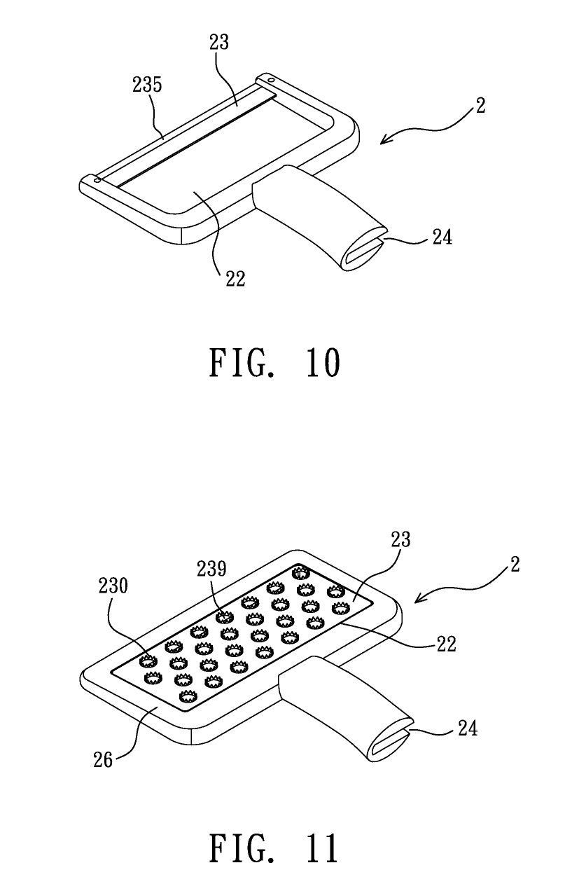

Referring from FIG. 1a to FIG. 10, where in FIG. 1a and FIG. 1b are perspective exploded views of the assembled peeler of the present invention being viewed from two different angles; FIG. 2 is a perspective view of the assembly of the assembled peeler of the present invention; FIG. 3 is a cross sectional view of FIG. 2 intercepted along an A-A line; FIG. 4 is a perspective view of the knife rack of the second embodiment of the present invention; FIG. 5 is a perspective view of the knife rack of the third embodiment of the present invention; FIG. 6 is a perspective view of the knife rack of the fourth embodiment of the present invention; FIG. 7 is a perspective view of the knife rack of the fifth embodiment of the present invention; FIG. 8 is a perspective view of the knife rack of the sixth embodiment of the present invention; FIG. 9 is a perspective view of the knife rack of the seventh embodiment of the present invention; FIG. 10 is a perspective view of the knife rack of the eighth embodiment of the present invention; FIG. 11 is a perspective view of the knife rack of the ninth embodiment of the present invention.

The assembled peeler provided by the present invention comprises a handle 1, and at least one knife rack 2.

The handle 1 is installed with a shuttle-shaped rod member 11, the front of the rod member 11 is axially and protrudingly provided with a buckling tenon 12, the tenon 12 is transversally extended with a tenon sheet 12a at the front center of the rod member 11, a mobile end of the tenon sheet 12a is formed with a protruding part 12b having a size larger than the size of the tenon sheet 12a and the shape thereof is e.g. a trapezoidal member whose rear end is wider then the front end. For providing directivity for assembling the handle 1 and the knife rack 2, the buckling tenon 12 is not extended to the left edge of the rod member 11 so as to form a lateral-facing notch.

Two clipping arms 21 are respectively installed at the two fronts of the knife rack 2 and served to define an opening 22 for receiving a knife tool 23; the rear of the knife rack 2 is radially installed with a buckling slot 24 that does not throughoutly penetrates a lateral wall of the knife rack 2; i.e. a blocking wall, that does not throughoutly penetrates, is defined at the lateral edge of the rear of the knife rack 2 corresponding to the location where the lateral-facing notch is formed. As shown in FIG. 1a and FIG. 1b, the shape and the size of the buckling slot 24 are corresponding to that of the buckling tenon 12, i.e. a clipping slot 24a is transversally installed at the rear center of the knife rack 2 for receiving the tenon sheet 12a, the front of the clipping slot 24a is formed with a mounting slot 24b communicating with the clipping slot 24a and having the shape and the size corresponding to that of the protruding part 12b.

When the handle 1 and the knife rack 2 are assembled, the buckling tenon 12 having the lateral-facing notch is aimed at and radially inserted into the buckling slot 24, such that the tenon sheet 12a and the protruding part 12b of the buckling tenon 12 are respectively received in the clipping slot 24a and the mounting slot 24b of the buckling slot 24, and the lateral-facing notch is tightly abutted against the left inner wall of the buckling slot 24, therefore the assembly of the handle 1 and the knife rack 2 is finished, the configuration thereof is as shown in FIG. 2.

Wherein, the installation means for the buckling tenon 12 of the handle 1 and the buckling slot 24 of the knife rack 2 is not limited to what is disclosed in this embodiment, for example the front of the handle can be radially installed with a buckling slot while the rear of the knife rack is axially and protrudingly installed with a buckling tenon, the same assembling effect is obtained thus the means is also included in this application.

As shown FIG. 3, which is a cross section view of FIG. 2 intercepted along an A-A line, because the size of the protruding part 12b is larger than that of the clipping slot 24a, the protruding part 12b is tightly abutted against the convex wall at the bottom of the clipping slot 24a, so when the knife tool 23 is applied with an axial force to peel the skins of foods, the buckling tenon 12 and the buckling slot 24 are prevented from axially separating, thus a food process operation is able to be easily operated.

Referring to FIG. 1a and FIG. 1b, the knife tool 23 is transversally pivoted on the opening 22 of the knife rack 2, and the rotation angle of the knife tool 23 is limited through a blocking effect generated by at least one blocker 25 protrudingly installed at inner opposite sides of the two clipping arms 21. The knife tool 23 is a metal sheet in which the front and rear being respectively installed with a lower peeling knife 231 and an upper arc-shaped sheet 232, wherein two ends of the lower peeling knife 231 respectively have a V-shaped bending, such that an arc-shaped slit is formed between the upper arc-shaped sheet 232 and a saw-shaped blade 233 formed at the rear of an arc-shaped protruding part defined at the center of the lower peeling knife 231; the upper arc-shaped sheet 232 is able to be moved along the top surface of a corn, and the saw-shaped blade 233 formed at the bottom is able to cut the corn, so corn grains are cut and fallen from the opening 22.

As shown in FIG. 4, which is a schematic view of the knife rack of the second embodiment of the present invention, wherein the shape and the size of the knife rack 2 in this embodiment are the same as that of the knife rack 2 described in the first embodiment; the difference between the mentioned two embodiments is the shape of the knife tool 23. The knife tool 23 is an arc-shaped metal sheet member transversally pivoted at the opening 22 of the knife rack 2, and the rotation angle of the knife tool 23 is limited through a blocking effect generated by at least one blocker 25 protrudingly installed at inner opposite sides of the two clipping arms 21, wherein the center of the sheet member is transversally installed with an elongated hollow slot 234 having a front edge equipped with an oblique peeling blade 235 for peeling skins of ordinary fruits such as apples.

As shown in FIG. 5, which is another state of the knife rack of the second embodiment of the present invention; the difference between this embodiment and the mentioned second embodiment is that the front and rear of the elongated hollow slot 234 are respectively installed with a saw-shaped blade 236, for cutting and peeling vegetables or fruits with hard skins such as kiwis.

As shown in FIG. 6, which is one another state of the knife rack of the second embodiment of the present invention; the difference between this embodiment and the mentioned second embodiment is that the front and rear of the elongated hollow slot 234 having a pre-set width are respectively installed with an oblique peeling blade 235 and a saw-shaped blade 236 for cutting and peeling vegetables or fruits such as potatoes into slices, and one surface of the cut potato slice has plural slots arranged in parallel, so cooking processes of baking or frying of potato slices can be facilitated.

As shown in FIG. 7, which is a schematic view of the knife rack of the fifth embodiment of the present invention; wherein the difference between the knife rack 2 in this embodiment and the mentioned embodiment is that the front of the knife rack 2 is installed with a frame 26 formed with an opening 22 for receiving a knife tool 23. The transversal-facing opening 22 is obliquely installed with a metal knife tool 23, the rear of the metal knife tool 23 is equipped with a wave-shaped blade 237 for cutting and peeling vegetables or fruits, such as cucumbers, to slices so two surfaces thereof have wave-like shapes.

As shown in FIG. 8, which is the schematic view of the knife rack of the sixth embodiment of the present invention; a transversal-facing opening 22 of the frame 26 installed at the front of the knife rack 2 is equipped with a knife tool 23, the surface of the knife tool 23 has several rows of oblique peeling holes 238, so vegetables and fruits such as carrots can pass through the peeling holes 238 so as to be peeled to filament-like shapes; wherein diameters of the oblique peeling holes 238 can be changed for peeling vegetables and fruits to filament-like shape with various diameters.

As shown in FIG. 9, which is a schematic view of the seventh embodiment of the present invention, wherein an opening 22 at the front of the knife rack 2 is pivoted with a knife tool 23, the knife tool 23 is a metal sheet member having a pre-set bending angle at the front and the rear, the sheet member is transversally provided with an elongated hollow slot 234 at the bended locations, the front of the hollow slot 234 is installed with an oblique peeling blade 235. When in use, the knife tool 23 is served to peel vegetables such as a cabbage or onion with multi layers so the peeled vegetables or fruits are in filament-like shapes.

As shown in FIG. 10, which is a schematic view of the eighth embodiment of the present invention, the opening 22 of the knife rack 2 in this embodiment is fastened with a knife tool 23, the front of the knife tool 23 is installed with an oblique peeling blade 235. When in use, the knife tool 23 is operated along a block-shaped food such as cheese for directly performing a slicing process.

As shown in FIG. 11, which is a schematic view of the ninth embodiment of the present invention, the transversal-facing opening 22 of the frame 26 at the front of the knife rack 2 is installed with a metal knife tool 23, the surface of the knife tool 23 is formed with several rows of round holes 239, and the circumference of each round hole 239 is formed with a plurality of convex teeth 230. When in use, vegetable such as garlic is grinded on top of the sharp convex teeth 230, so grinded garlic is fallen from the round holes 239.

The advantages provided by the present invention are as follows: the buckling tenon and the buckling slot at combination locations of the handle and the knife rack are combined with a radial mounting means, instead of a direct axial insertion, so a user is prevented from accidentally touching the knife tool and injured when the axial insertion is operated; moreover, with a design that a single handle can be combined various types of knife racks, the food processes such as peeling, chopping, slicing, grinding or splitting can be selected. Therefore the assembled peeler of the present invention is novel compared to conventional peelers.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An assembled peeler, comprising:
a rod-shaped handle, the front thereof being axially and protrudingly installed with a buckling tenon or radially installed with a buckling slot; and
at least one knife rack, the front thereof being formed with an opening for receiving a knife tool, and the rear of each knife rack being radially installed with a buckling slot or axially and protrudingly installed with a buckling tenon;
said handle and said knife rack being combined as one piece through radially inserting said buckling tenon into said buckling slot, such that said knife tool of said knife rack being able to be axially forced and operated.

2. The assembled peeler as claimed in claim 1, wherein said buckling tenon is transversally extended with a tenon sheet at the center of the front of said handle or the rear of said knife rack, a mobile end of said tenon sheet is installed with a protruding part having a size larger than that of said tenon sheet; said buckling slot is transversally installed with a clipping slot at the center of the rear of said knife rack or the front of said handle for receiving said tenon sheet, the rear of said clipping slot is formed with a mounting slot communicating with said clipping slot and having a size and shape corresponding to that of said protruding part.

3. The assembled peeler as claimed in claim 2, wherein said protruding part and said mounting slot is a trapezoidal member in which the rear end is wider then the front end.

4. The assembled peeler as claimed in claim 1, wherein said buckling tenon is formed with a lateral-facing notch at a lateral edge of the front of said handle or the rear of said knife rack, and said buckling slot is formed with a non-throughout blocking wall at a lateral edge of the rear of said knife rack or the front of said handle and is installed corresponding to the location where said lateral-facing notch is formed.

5. The assembled peeler as claimed in claim 1, wherein two ends of said knife rack are extended with a pair of clipping arms, an opening is defined by said pair of clipping arms for receiving a knife tool.

6. The assembled peeler as claimed in claim 5, wherein at least one blocker is protrudingly installed at inner opposite sides of said pair of clipping arms for limiting the rotation angle of said knife tool.

7. The assembled peeler as claimed in claim 5, wherein said knife tool is transversally pivoted at said opening of said knife rack, and said knife tool is a metal sheet member in which the front and rear being respectively installed with a lower peeling knife and an upper arc-shaped sheet, wherein two ends of said lower peeling knife respectively have a V-shaped bending, such that an arc-shaped slit is formed between said upper arc-shaped sheet and a saw-shaped blade formed at the rear of an arc-shaped protruding part defined at the center of said lower peeling knife.

8. The assembled peeler as claimed in claim 5, wherein said knife tool is transversally pivoted at said opening of said knife rack, and said knife tool is an arc-shaped metal sheet member in which an elongated hollow slot is transversally installed at the center, and the front of said hollow slot is equipped with an oblique peeling blade.

9. The assembled peeler as claimed in claim 5, wherein said knife tool is transversally pivoted at said opening of said knife rack, and said knife tool is an arc-shaped metal sheet member in which an elongated hollow slot is transversally installed at the center, and the front and rear of said hollow slot are respectively equipped with a saw-shaped blade.

10. The assembled peeler as claimed in claim 5, wherein said knife tool is transversally pivoted at said opening of said knife rack, and said knife tool is an arc-shaped metal sheet member in which an elongated hollow slot is transversally installed at the center, and the front and rear of said hollow slot are respectively equipped with an oblique peeling blade and a saw-shaped blade.

11. The assembled peeler as claimed in claim 5, wherein said knife tool is transversally pivoted at said opening of said knife rack, and said knife tool is a metal sheet member in which the front and rear are formed with a pre-set bending angle, said sheet member is transversally installed with an elongated hollow slot at the bended locations, the front of said hollow slot is quipped with an oblique peeling blade.

12. The assembled peeler as claimed in claim 5, wherein said knife tool is transversally pivoted at said opening of said knife rack, and the front of said knife tool is equipped with an oblique peeling blade.

13. The assembled peeler as claimed in claim 1, wherein the front of said knife rack is installed with a frame formed with an opening for receiving a knife tool.

14. The assembled peeler as claimed in claim 13, wherein said knife tool is fastened at said transversal-facing opening of said frame installed at the front of said knife rack, and the rear of said knife tool is equipped with a wave-shaped blade.

15. The assembled peeler as claimed in claim 13, wherein said knife tool is fastened at said transversal-facing opening of said frame installed at the front of said knife rack, and the surface of said knife tool is equipped with plural rows of oblique peeling holes.

16. The assembled peeler as claimed in claim 13, wherein said knife tool is fastened at said transversal-facing opening of said frame installed at the front of said knife rack, and the surface of said knife tool is equipped with plural rows of round holes, and the circumference of each round hole has a plurality of sharp convex teeth.
